(19) United States
(12) Patent Application Publication
(10) Pub. No.: US 2026/0257087 A1
(43) Pub. Date: Sep. 3, 2026

(54) ENDLESS SLEEVE FOR A PIPE

(71) Applicant: Hilti Aktiengesellschaft, Schaan (LI)

(72) Inventors: Hoda Azimi, Augsburg (DE); Christian Förg, Buchloe (DE); Erica Olschnoegger, Schellenberg (LI); Danesh Jehangir Morris, St. Gallen (CH); Kam Fai Wai, Sennwald (CH)

(73) Assignee: Hilti Aktiengesellschaft, Schaan (LI)

(21) Appl. No.: 18/873,085

(22) PCT Filed: May 31, 2023
(86) PCT No.: PCT/EP2023/064519

§ 371 Date: Dec. 9, 2024

(30) Foreign Application Priority Data
Jun. 14, 2022 (EP) 22178805.2

(51) Int. Cl. A62C 2/06; F16L 5/04

(52) U.S. Cl. CPC A62C 2/065; F16L 5/04

(57) ABSTRACT

An endless sleeve for a pipe is continuous and is made of a hybrid material, optionally a metal strip and multiple mounting devices. The hybrid material has at least one first layer and a carrier layer arranged parallel to and surface-bonded with the first layer. The first layer at least in part has an intumescent material. The hybrid material is arranged in multiple layers around the pipe. The optional metal strip can be arranged on the outside adjacent to the hybrid material in a radial direction of the pipe. The mounting devices are configured to enclose the hybrid material and, if applicable, the metal strip at least partially along an axial direction of the pipe. The continuous sleeve is configured to be fixed to an external receptacle by the mounting devices. The carrier layer has a mesh structure,

The present invention relates to an endless sleeve for a pipe.

Fire protection sleeves are used to provide solutions for sealing off pipes, in particular plastic pipes, which are routed through walls. The aim is to close off the wall opening through which the pipe is routed in the event of a fire as soon as the melted or burned pipe no longer provides a seal. For this purpose, fire protection sleeves have an intumescent material. Intumescent materials have the property of expanding above a certain threshold temperature. During the expansion, the material foams up and then carbonizes, thereby providing a thermally insulating resistant layer. In the event of a fire, the wall opening can thus be reliably closed off in order to prevent the flames from spreading through the wall opening into adjacent spaces.

Fire protection sleeves are known which have special housing shapes. The housing then comprises a receiving space for the intumescent material. However, the positioning of the typically multi-layer strip packet of the intumescent material within the receiving space is associated with a relatively large amount of manual work, thus complicated and cost-intensive.

In addition, the housings typically have complex geometries which, depending on the respective pipe diameter, also differ from one another. As a result, different punching and bending tools are required for production in relation to the different pipe diameters. For the manufacturer, the amortization time of these tools is often very long, especially in the case of infrequently installed pipe sizes. The comparatively small quantities that can be sold on the market therefore often do not justify the investment in such specific and thus cost-intensive tools.

Furthermore, the housings require an increased space requirement during storage due to their geometries.

The invention is therefore based on the object of providing a fire protection sleeve by means of which the disadvantages of known fire protection sleeves can be eliminated or at least reduced. In particular, the respective wall opening should be reliably closed when required. In addition, the requirement of special housing geometries depending on the respective pipe diameter should preferably be avoided as much as possible. Furthermore, it is advantageous if only a reduced storage space requirement is required and if the sleeve is easy to install for the user or installer.

The object is achieved by subject matter of the independent claim. Advantageous embodiments are specified in the dependent claims and the following description, each of which can represent aspects of the invention per se or in (sub-)combination.

According to one aspect, a continuous sleeve for a pipe is provided. The continuous sleeve is a fire protection sleeve. The continuous sleeve comprises a hybrid material, optionally a metal strip and multiple mounting devices. The hybrid material comprises at least one first layer and a carrier layer arranged parallel to and surface-bonded with the first layer. The first layer at least in part has an intumescent material. The hybrid material is arranged in multiple layers around the pipe. The optional metal strip can be arranged on the outside adjacent to the hybrid material in a radial direction of the pipe. The mounting devices are configured to enclose the hybrid material and, optionally, the metal strip at least partially along an axial direction of the pipe. The continuous sleeve can be fixed to an external receptacle by means of the mounting devices. The carrier layer has a mesh structure.

The continuous sleeve formed in this way advantageously manages without a complex-shaped housing. The mesh structure ensures sufficient mechanical stability even in the event of a fire when the intumescent material expands. The mesh structure also provides permeability for the intumescent material so that the intumescent material can connect adjacent layers of the hybrid material to one another and a direct coupling is made possible. This improves the sealing of the opening for the pipe after said pipe is burned or melted. Furthermore, the manufacturing process manages without expensive punching and bending tools so that the manufacturing effort is reduced. In addition, the elaborate positioning steps are also omitted when arranging the intumescent material in a receiving space of a housing. As a further aspect, the required storage space is reduced by the avoidance of complex housing geometries. It is also only necessary to produce and procure only one endless component (hybrid material) regardless of the respective pipe diameter. The installer only cuts the correct length of the endless sleeve, i.e., of the hybrid material and, optionally, of the metal strip, depending on the respective pipe diameter and then installs the continuous sleeve.

In the present context, a hybrid material is understood to mean a material which has at least two different material components. In the present case, the different material components are arranged in parallel layers in the hybrid material.

The hybrid material is arranged in multiple layers around the pipe. This means that the hybrid material is routed around the pipe multiple times. The number of layers of the hybrid material generally depends on the diameter of the pipe and thus on the size of the wall opening. Therefore, there are at least two layers of the hybrid material around the pipe in the usage situation. In particular, the hybrid material in the usage situation can have at least two, preferably between four and seven layers.

The metal strip, which can be arranged on the outside of the hybrid material radially with respect to the center of the pipe and thus with respect to the continuous sleeve, forces the intumescent material in the direction of the center in the event of a fire when it expands. As a result, the sealing of the opening for the pipe can be improved.

The mounting devices ensure substantially the correct positioning of the continuous sleeve with respect to the opening for the pipe. Furthermore, they prevent a relative movement of the continuous sleeve with respect to the pipe.

In the present case, the term “enclose” is to be understood as meaning that the mounting devices surround the hybrid material at least in a positive-locking manner, in particular also in a frictional and/or positive-locking manner, in such a way that the hybrid material is thereby fixed in its relative position with respect to the external receptacle and the pipe. Optionally, the mounting device can have a clamping connection or a hook connection for fixing the hybrid material.

The external receptacle is generally the structure which has the opening for the pipe.

In a preferred embodiment, the carrier layer has a glass fiber material and/or an aluminum material. Also preferred are glass fiber or metal wire grids or a composite of both. Such materials are well suited to ensure sufficient mechanical stability, even in the event of a fire.

Alternatively or cumulatively, the hybrid material comprises a fabric. In particular, at least the carrier layer can have a fabric. Fabric structures are produced in an industrially standardized manner, so that the manufacturing effort is low. Nevertheless, they ensure high mechanical stability. Fabric structures are therefore well suited to absorb the intumescence forces of the intumescent material expanding in the event of fire and to resist this.

In a particular embodiment, the mesh structure has a diamond mesh structure or a rectangular mesh structure. These geometries have proven to be particularly well suited with regard to sufficient mechanical stability and a simultaneously advantageous permeability for the intumescent material.

Particularly preferably, the mesh structure has substantially uniform mesh openings with a first and a second edge length. The first and the second edge length are at least 2 mm and up to 10 mm. Preferably, the first and second edge lengths are at least 3 mm and up to 6 mm. Further preferably, the first and second edge lengths are at least 3.5 mm and up to 4 mm. These edge lengths of the mesh openings enable a good compromise between an advantageous low material consumption and, on the other hand, sufficient mechanical stability.

Optionally, the intumescent material has graphite particles. A particle size of the graphite particles may be substantially 0.4 mm. The particle size has proven to be particularly suitable with respect to the edge lengths of the mesh openings. It is thus ensured that the graphite particles of the intumescent material can pass through the mesh openings, so that in the event of fire a coupling of adjacent layers of the hybrid material is made possible.

The hybrid material preferably further comprises a third layer which is arranged parallel to the carrier layer and is bonded to the surface thereof. The third layer can have a film made of a plastic material. The third layer enables simplified manufacture, because the hybrid material can be transported and processed in the manufacturing plant based on the third layer. This prevents, for example, the carrier layer arranged on the third layer or the layer of the intumescent material from being damaged during the processing.

Optionally, the mounting devices can have at least one hook portion and one finger portion. The finger portion can be arranged in the radial direction of the pipe adjacent to the hybrid material. The hook portion can be arranged at least in the radial direction of the pipe at least in part on the outside, optionally, adjacent to the metal strip. This ensures a simple but effective enclosure of the hybrid material and, optionally, of the metal strip relative to the pipe. Thus, the mounting device allows positioning of the hybrid material with respect to the pipe and the external receptacle.

The hook portion can preferably have at least one eyelet, an elongated hole or a corresponding portion by means of which the respective mounting device can be fixed to the external receptacle, and which provides at least a degree of freedom with respect to the positioning.

Preferably, the finger sections are bendable at least between a first and a second orientation direction. The first orientation direction is oriented substantially parallel to the axial direction of the pipe. The second orientation direction is arranged substantially along the radial direction of the pipe. Thus, the hybrid material of the continuous sleeve can first be enclosed in the axial direction by the finger portion. If the pipe melts or burns, the finger portion, due to the intumescence, bends in the direction of the center of the pipe or the continuous sleeve, so that the intumescent material can further take up the cleared radially inner space in order to seal off the opening.

In general, the hybrid material, the optional metal strip and the mounting devices represent separate components, even if they are coupled to one another at least in a positive-locking manner in the usage situation and therefore form the continuous sleeve as a common unit. In an alternative approach, they may, however, also be regarded together as a system which overall forms the continuous sleeve. According to this alternative view, all of the subject matter aspects claimed are to be transferred analogously to an endless sleeve comprising a system which has at least the aforementioned components.

All of the features explained with respect to the various aspects can be combined individually or in (sub-)combination with other aspects.

The invention and further advantageous embodiments and further developments thereof are described and explained in more detail below with reference to the examples shown in the drawing. The features to be taken from the description and the drawing can be applied individually or together in any combination according to the invention. In the drawings:

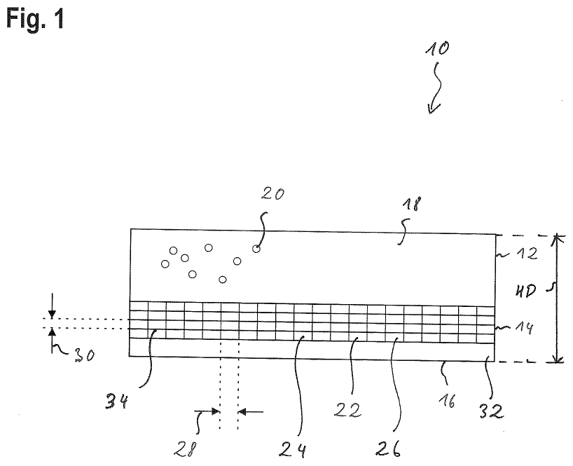

FIG. 1 shows a simplified schematic view of the hybrid material according to one embodiment,

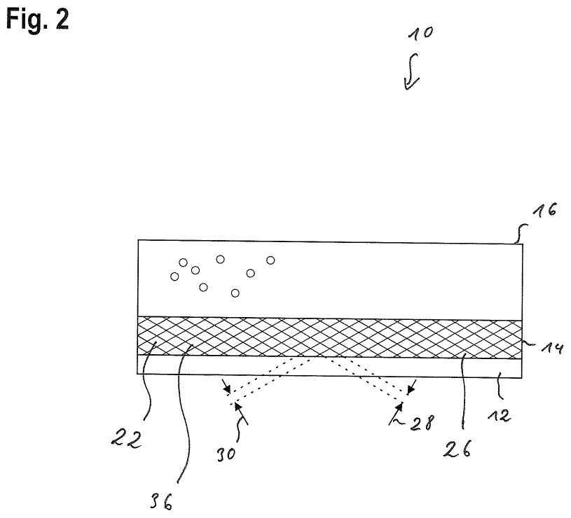

FIG. 2 shows a simplified schematic view of the hybrid material according to a further embodiment,

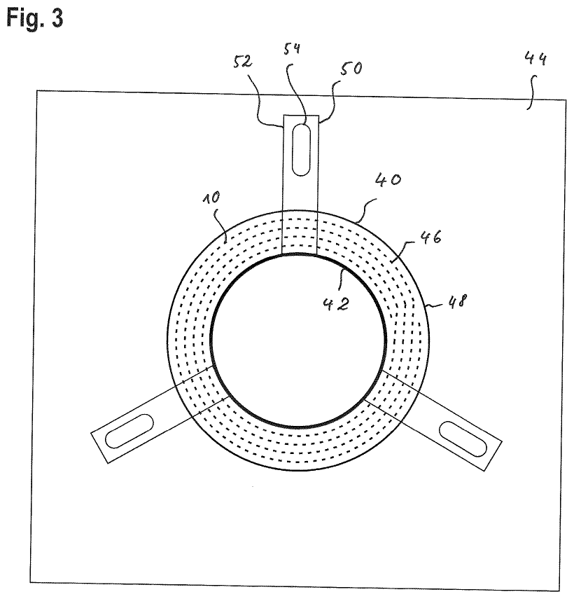

FIG. 3 shows a simplified schematic view of the continuous sleeve, the pipe and the external receptacle, and

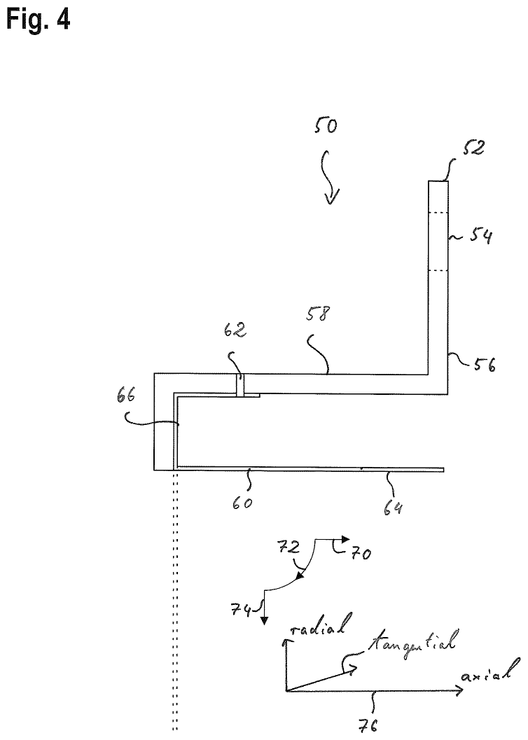

FIG. 4 shows a simplified schematic view of a mounting device.

All features disclosed below with respect to the exemplary embodiments and/or accompanying figures may be combined alone or in any sub-combination with features of the aspects of the present disclosure, including features of preferred embodiments, provided that the resulting feature combination is useful for a person skilled in the art in the field of technology.

FIG. 1 shows a simplified schematic representation of the hybrid material 10 according to one embodiment. The hybrid material 10 is shown here according to a cross-sectional view.

The hybrid material 10 comprises a first layer 12, a carrier layer 14 (also called a second layer) and a third layer 16. The first layer 12, the carrier layer 14 and the third layer 16 are stacked along the layer thickness HD of the hybrid material 10. This means that the layers 12, 14, 16 are arranged parallel to one another along the longitudinal extension direction of the hybrid material 10 and along the width of the hybrid material 10 and are surface-bonded to one another in pairs. Suitable coupling means, for example an adhesive, can be provided for coupling the different layers 12, 14, 16.

The first layer 12 at least partially comprises the intumescent material 18. In addition to the intumescent material 18, the first layer 12 can also have other ingredients. In the present case, the intumescent material 18 comprises graphite particles 20. The graphite particles 20 have a particle size of substantially 0.4 mm. The particle size here refers to an average diameter of a graphite particle 20, which can be assumed to be spherical in a first approximation. Alternatively, the graphite particles 20 can also have other geometries. However, the largest expansion of the respective particle geometry is substantially 0.4 mm.

The carrier layer 14 is arranged adjacent to the first layer 12. The carrier layer 14 has a mesh structure 22. In the present case, the mesh structure 22 is designed as a rectangular mesh structure 24. The rectangular mesh structure 24 has substantially uniform rectangular mesh cells 26.

In the present case, the individual mesh cells 26 have a first edge length 28 and a second edge length 30. In this embodiment, the first edge length 28 and the second edge length 30 are at least 3.5 mm and up to 4 mm.

Even if the openings of the mesh cells 26 are formed here only perpendicular to the longitudinal extension direction and the layer thickness HD of the hybrid material 10 based on the cross-sectional view, the mesh cells 26 can also have openings along the layer thickness HD.

The third layer 16 has a film 32, which, in the present case, comprises a plastic material.

In the event of a fire, the graphite particles 20 foam up and expand. This leads overall to an expansion of the first layer 12 and thus of the hybrid material 10. The particle size of the graphite particles 20 in relation to the edge lengths 28, 30 of the mesh cells 26 ensures that the intumescent material 18, including the graphite particles 20, can pass through the mesh cells 26 in part. Since the film 32 melts in the event of a fire, a coupling between the intumescent material 18 of adjacent, stacked layers of the hybrid material 10 can thus be ensured. This creates a loadable mechanically stable coupling which can be used to seal off a wall opening.

In order to ensure sufficient mechanical stability of the hybrid material 10, at least the carrier layer 14 has a fabric 34. The mesh cells 26 are thus formed from a fabric 34.

Optionally, the first layer 12 and/or the third layer 16 can also have the fabric 34.

Alternatively, the fabric 34 can differ from one layer to the other in each layer 12, 14, 16.

The carrier layer 14 can also be regarded as a second layer.

The mesh structure 22 of the carrier layer 14 preferably has a glass fiber material and/or an aluminum material.

FIG. 2 shows a simplified schematic representation of the hybrid material 10 according to a further embodiment. Only differences from the preceding embodiment are discussed here.

In contrast to the preceding embodiment, the carrier layer 14 has a mesh structure 22 which comprises a diamond mesh structure 36. The edge lengths 28, 30 of the mesh cells 26 of the diamond mesh structure 36 correspond to those of the rectangular mesh structure 24 from the preceding embodiment.

The remaining structure of the hybrid material 10 corresponds to that of the preceding embodiment.

The choice of the shape of the mesh cells 26 has an influence on the mechanical stability. This means that, for example, the diamond mesh structure 36 may be preferred in particularly stressed applications.

FIG. 3 shows a simplified schematic illustration of the continuous sleeve 40, of the pipe 42 and of the external receptacle 44. The components are shown according to a cross-sectional view.

The continuous sleeve 40 comprises the hybrid material 10, which is arranged in a multi-layered manner around the pipe 42. The number of layers 46 generally depends on the diameter of the pipe 42.

The continuous sleeve 40 may further comprise a metal strip 48, which can be arranged radially on the outside relative to the center of the endless sleeve 40 and thus to the center of the pipe 42 adjacent to the hybrid material 10.

The endless sleeve 40 further comprises multiple mounting devices 50, in this case three, which on the one hand serve for positioning the endless sleeve 40 and on the other hand ensure correct positioning of the hybrid material 10 and, optionally, of the metal strip 48 relative to the pipe 42. The mounting devices 50 surround the hybrid material 10 and, if applicable, the metal strip 48 at least in part at least along the axial direction of the pipe 42. The mounting devices 50 thus prevent the hybrid material 10 or, optionally, the metal strip 48 from moving along the axial direction, the radial direction or the circumferential direction of the pipe 42.

Since, in a preferred embodiment, the metal strip 48 is also enclosed by the mounting devices 50, the intumescent material 18 is forced in the radial direction of the pipe 42 toward the center when it expands in the event of a fire.

Thus, if the pipe 42 burns or melts, the intumescent material 18 can take up the vacated space and close off the corresponding opening in the external receptacle 44, for example of a wall. Furthermore, the intumescent material 18 of the adjacent layers 46 of the hybrid material 10 passes through the mesh cells 26 and couples to itself, so that a mechanically stable sealing is ensured.

The mounting devices 50 have at least hook portions 52, by means of which the endless sleeve 40 can be fixed to the external receptacle 44. The hook portions 52 advantageously have an elongated hole 54 in order to provide at least a degree of freedom during the fixing.

FIG. 4 shows a simplified schematic illustration of a mounting device 50 according to a side view.

The mounting device 50 has a hook portion 52 with an elongated hole 54 for fixing to the external receptacle 44. After the fixation on the external receptacle 44, the contact surface 56 is arranged adjacent to the external receptacle 44.

Furthermore, the hook portion 52 of the mounting device 50 has a substantially L-shaped base portion 58. The long leg of the L-shaped base section 58 is oriented along the axial direction of the pipe 42 in the usage situation. The short leg of the L-shaped base section 58 is oriented along the radial direction of the pipe 42 in the usage situation.

The mounting device 50 further comprises a finger portion 60 which extends at least partially along the axial direction. The finger portion 60 is coupled to the base portion 58 by suitable connecting means 62, for example by screws, rivets, an adhesive, or the like. Alternatively, the finger portion 60 can also be manufactured together with the hook portion 52 from a material, but the bending region must be designed in such a way that the finger portion 60 can bend with little force in the event of a fire.

While, in the usage situation, the long leg of the L-shaped base section 58 is arranged radially outwardly relative to the hybrid material 10 and, optionally, to the metal strip 48 of the endless sleeve 40, the finger portion 60 in the usage situation is arranged radially inwardly relative to the hybrid material 10 and, if applicable, to the metal strip 48 of the endless sleeve 40. An outer surface 64 of the finger portion 60 is then arranged adjacent to the pipe 42.

Along the axial direction, the hybrid material 10 and in some cases the metal strip 48 are enclosed in the usage situation between the external receptacle 44 and the abutment surface 66.

Along the radial direction, the hybrid material 10 and in some cases the metal strip 48 are enclosed in the usage situation between the finger portion 60 and the long leg of the L-shaped base portion 58.

In a particularly preferred embodiment, the hybrid material 10 and the metal strip 48 are overall enclosed by the mounting device 50.

In the event of a fire, the intumescent material 18 expands. In order not to hinder this expansion, the finger portion 60 is such that it can bend from a first orientation direction 70 along the axial direction of the pipe 42 due to a bending 72 in a second orientation direction 74 along the radial direction of the pipe 42. As a result, the expansion of the intumescent material 18 is given more space. Furthermore, it is thus made possible that the space vacated by the melting or burning pipe 42 can be occupied by the intumescent material 18.

In contrast to the finger portion 60, the base portion 58 and also the hook portion 52 overall essentially are not distorted in the event of a fire, at least not in the typical fire conditions.

As an aid, the coordinate system 76 schematically illustrates the orientation with respect to the pipe 42. In this case, it is tangentially related to the circumferential direction of the pipe 42.

In the present disclosure, reference may be made to quantities and numbers. Unless expressly stated, such amounts and numbers are to be considered not as limiting but as examples of the possible amounts or numbers in connection with the present disclosure. In this context, the term “plurality” may also be used in the present disclosure to refer to an amount or number. In this context, the term “plurality” refers to any number that is greater than one, e.g., two, three, four, five, etc. The terms “approximately,” “about,” “close to,” etc. mean plus or minus 5% of the given value.

1. An endless sleeve for a pipe, comprising:
a hybrid material, optionally a metal strip, and at least one mounting device, wherein the hybrid material comprises at least one first layer and a carrier layer arranged parallel to and surface-bonded with the first layer, wherein the first layer at least partially has an intumescent material, wherein the hybrid material is arranged in a multi-layer manner around the pipe, and, optionally, the metal strip is arranged in a radial direction of the pipe on an outside adjacent to the hybrid material, wherein the at least one mounting device is configured to surround the hybrid material and, optionally, the metal strip at least partially along an axial direction of the pipe, and wherein the endless sleeve is fixable to an external receptacle by the at least one mounting device, wherein the carrier layer has a mesh structure.

2. The endless sleeve according to claim 1, wherein the carrier layer comprises a glass fiber material and/or aluminum.

3. The endless sleeve according to claim 1, wherein the hybrid material comprises a fabric.

4. The endless sleeve according to claim 1, wherein the mesh structure has a diamond mesh structure or a rectangular mesh structure.

5. The endless sleeve according to claim 1, wherein the mesh structure has substantially uniform mesh openings with a first and a second edge length, and wherein the first and second edge length is at least 2 mm and up to 10 mm.

6. The endless sleeve according to claim 1, wherein the intumescent material has graphite particles, and a particle size of the graphite particles is substantially 0.4 mm.

7. The endless sleeve according to claim 1, wherein the hybrid material further comprises a third layer which is arranged parallel to the carrier layer and is surface-bonded to it, and the third layer having a film made of a plastics material.

8. The endless sleeve according to claim 1, wherein the at least one mounting device has at least one hook portion and one finger portion, and wherein the finger portion is arranged in a radial direction of the pipe on an inside adjacent to the hybrid material and the hook portion is arranged, at least in the radial direction of the pipe, at least partially adjacently on an outside, optionally against the metal strip.

9. The endless sleeve according to claim 8, wherein the finger portion is bendable at least between a first and a second orientation direction, wherein the first orientation direction is oriented substantially parallel to an axial direction of the pipe, and wherein the second orientation direction is arranged substantially along the radial direction of the pipe.
